(19) United States
(12) Patent Application Publication
(10) Pub. No.: US 2025/0384106 A1
(43) Pub. Date: Dec. 18, 2025

(54) CONVOLUTION OPERATION DEVICE

(71) Applicant: NEUCHIPS CORPORATION, Hsinchu City (TW)

(72) Inventors: YuShan Ruan, New Taipei City (TW); Chiung-Liang Lin, Taichung City (TW); Huan Jan Chou, Taipei City (TW)

(73) Assignee: NEUCHIPS CORPORATION, Hsinchu City (TW)

(21) Appl. No.: 18/767,935

(22) Filed: Jul. 9, 2024

(30) Foreign Application Priority Data
Jun. 13, 2024 (TW) 113121952

(51) Int. Cl. G06F 17/15; G06F 5/01; G06F 7/544

(52) U.S. Cl. CPC G06F 17/15; G06F 5/01; G06F 7/5443

(57) ABSTRACT

The invention provides a convolution operation device, which includes a first memory, a second memory, a third memory, a first multiply-accumulate circuit, a second multiply-accumulate circuit, and a routing and shift register circuit. Different elements of a same matrix are stored in different memories. The first multiply-accumulate circuit and the second multiply-accumulate circuit access a convolution kernel from the first memory. During a first period, the routing and shift register circuit transmits a first element of the matrix from the second memory to the first multiply-accumulate circuit, and transmits a second element of the matrix from the third memory to the second multiply-accumulate circuit. During a second period, the routing and shift register circuit transmits the second element of the third memory to the first multiply-accumulate circuit.

### CROSS-REFERENCE TO RELATED APPLICATION

This application claims the priority benefit of Taiwan application serial no. 113121952, filed on Jun. 13, 2024. The entirety of the above-mentioned patent application is hereby incorporated by reference herein and made a part of this specification.

### BACKGROUND

### Technical Field

The invention relates to an electronic circuit, and more particularly, to a convolution operation device.

### Description of Related Art

Convolution operation is one of common operations in neural network models. If a matrix is used for the convolution operation, in order to improve efficiency of a computing device, element data input to the matrix may be copied multiple times and stored in different memories corresponding to different multiply-accumulate (MAC) operators. It is conceivable that redundant storage of the element data may affect memory usage efficiency.

### SUMMARY

The invention is directed to a convolution operation device, which prevents same elements of a matrix from being redundantly stored in different memories.

In an embodiment of the invention, the convolution operation device includes a first memory, a second memory, a third memory, a first multiply-accumulate circuit, a second multiply-accumulate circuit, and a routing and shift register circuit. The first memory is configured to store a convolution kernel. The second memory is configured to store a first element of a matrix. The third memory is configured to store a second element of the matrix. The first multiply-accumulate circuit and the second multiply-accumulate circuit are coupled to the first memory to access the convolution kernel. The routing and shift register circuit is coupled to the second memory, the third memory, the first multiply-accumulate circuit and the second multiply-accumulate circuit. During a first period, the routing and shift register circuit transmits the first element of the second memory to the first multiply-accumulate circuit, and transmits the second element of the third memory to the second multiply-accumulate circuit. During a second period, the routing and shift register circuit transmits the second element of the third memory to the first multiply-accumulate circuit.

Based on the above description, different parts of the matrix are stored in different memories to avoid redundant storage of element data. When a target element required by a certain multiply-accumulate circuit for calculation is not in the corresponding memory, the routing and shift register circuit may take out the target element from the memory corresponding to another multiply-accumulate circuit and transmit it to the certain multiply-accumulate circuit. Therefore, the convolution operation device provides a hardware computing framework that improves memory efficiency.

In order for the aforementioned features and advantages of the invention to be more comprehensible, several embodiments accompanied with drawings are described in detail as follows.

### BRIEF DESCRIPTION OF THE DRA WINGS

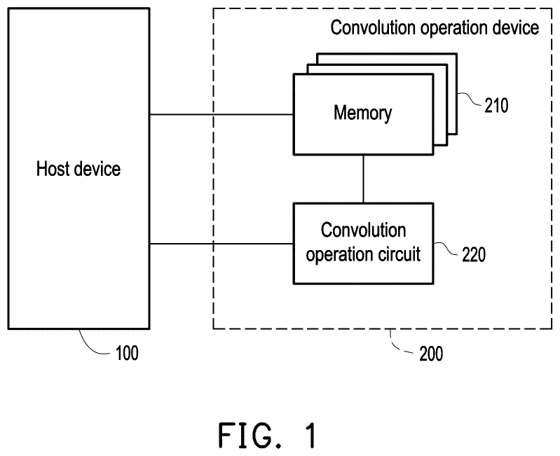

FIG. 1 is a schematic circuit block diagram of a convolution operation device according to an embodiment of the invention.

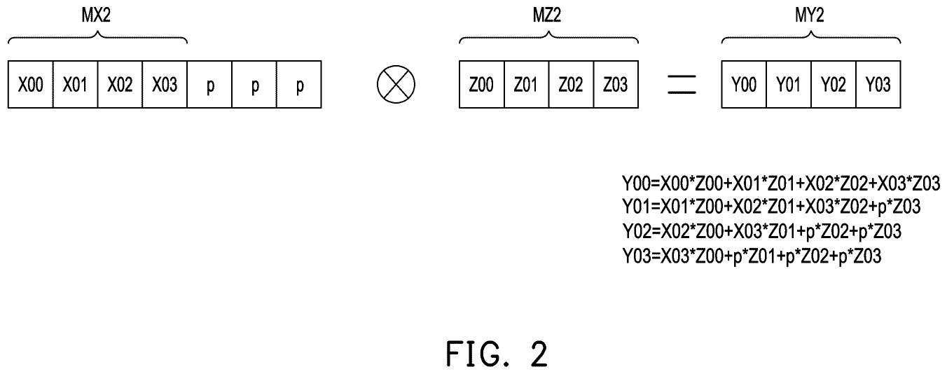

FIG. 2 is a schematic diagram of a convolution operation according to an application example.

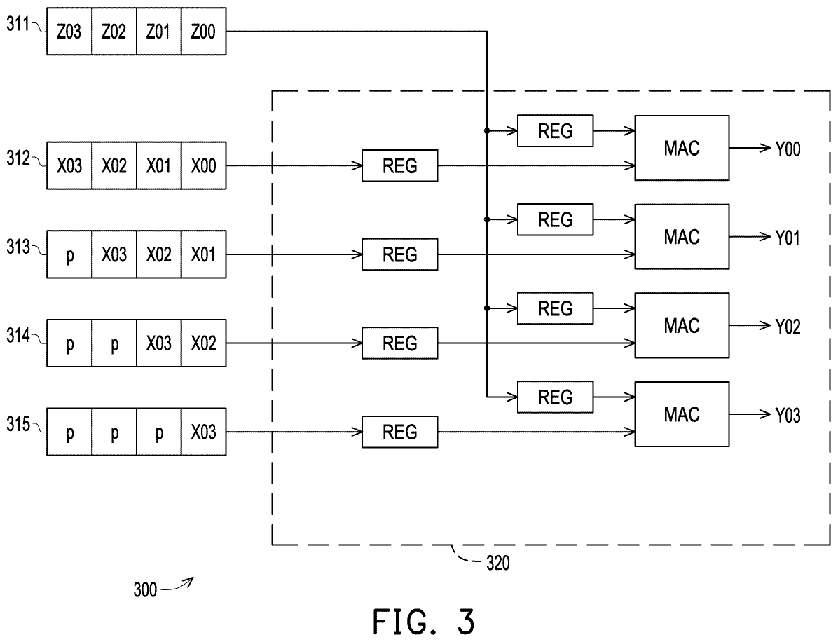

FIG. 3 is a schematic circuit block diagram of a convolution operation device according to an embodiment of the invention.

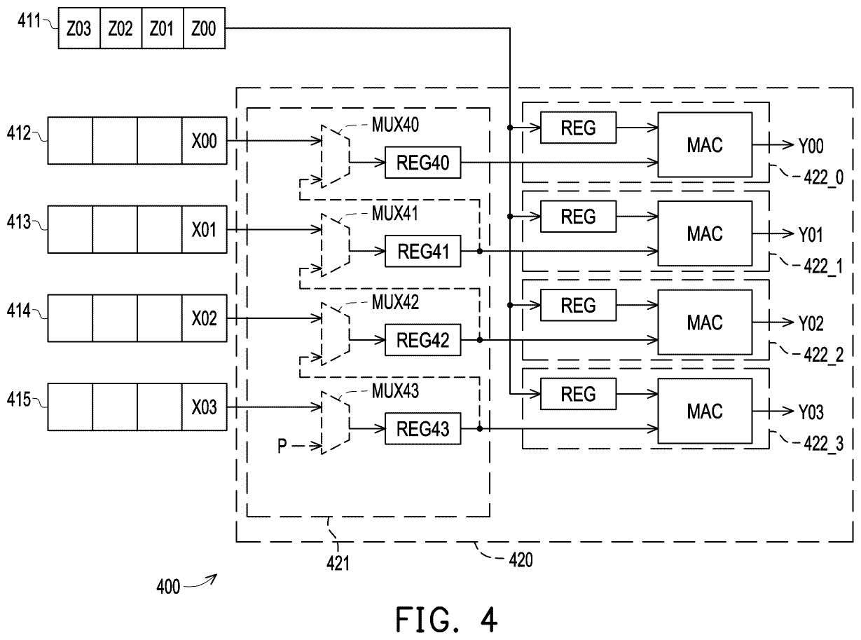

FIG. 4 is a schematic circuit block diagram of a convolution operation device according to an embodiment of the invention.

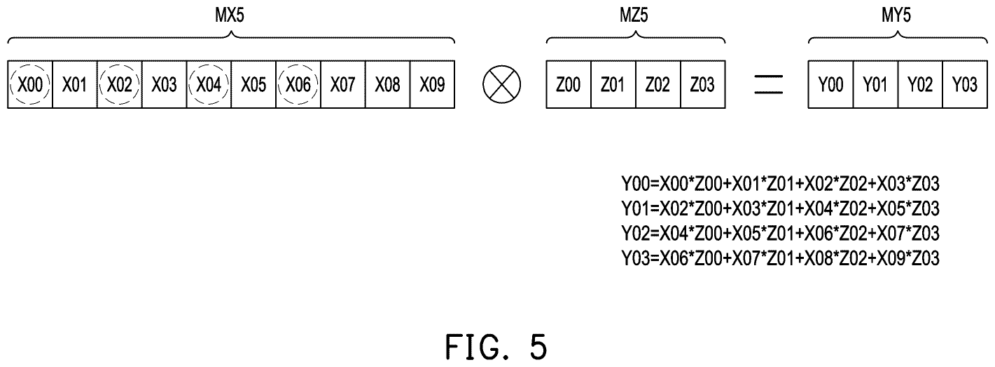

FIG. 5 is a schematic diagram of a convolution operation according to another application example.

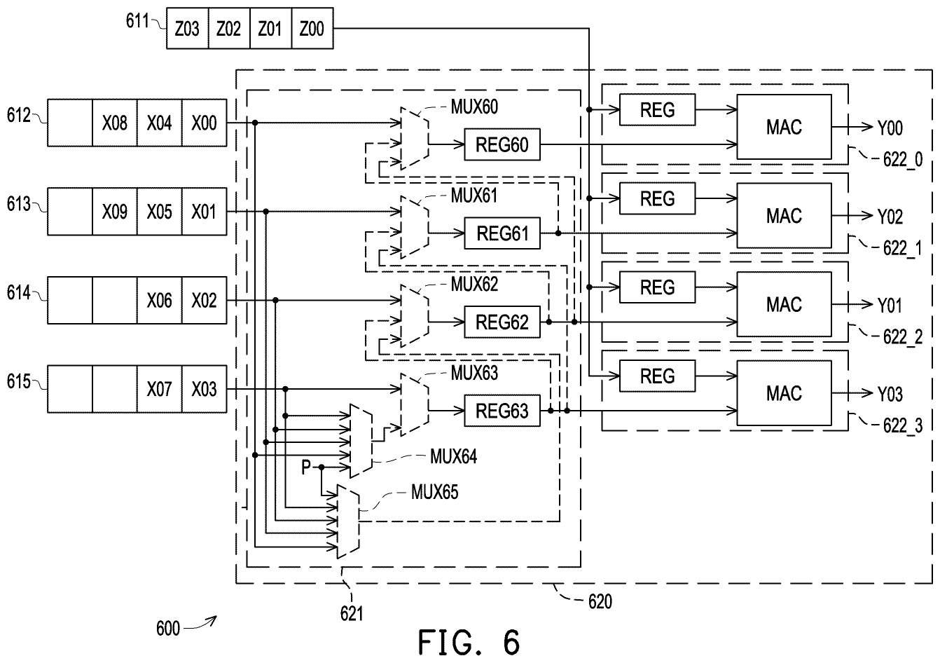

FIG. 6 is a schematic circuit block diagram of a convolution operation device according to another embodiment.

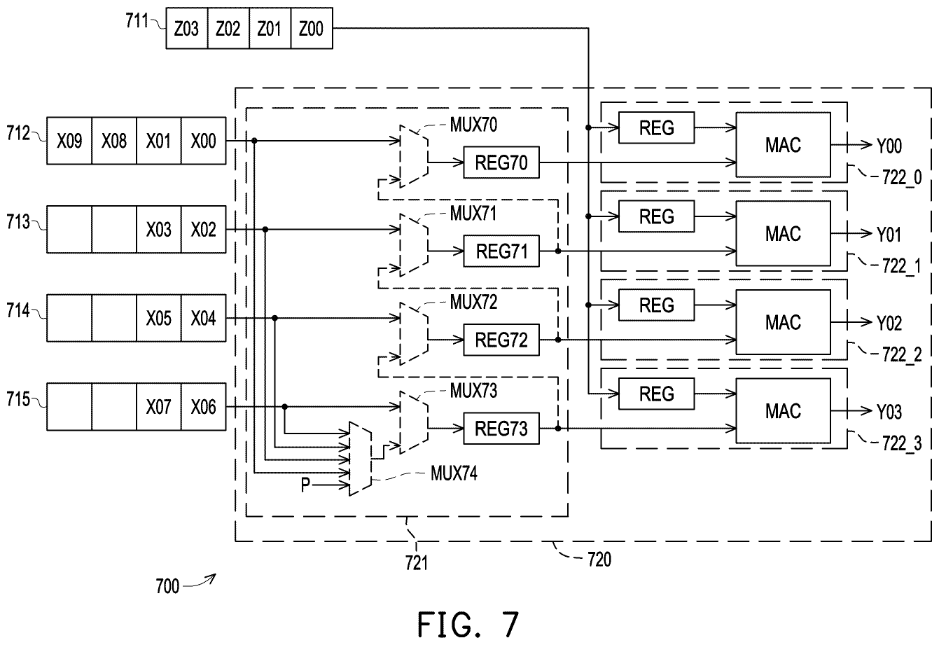

FIG. 7 is a schematic circuit block diagram of a convolution operation device according to still another embodiment.

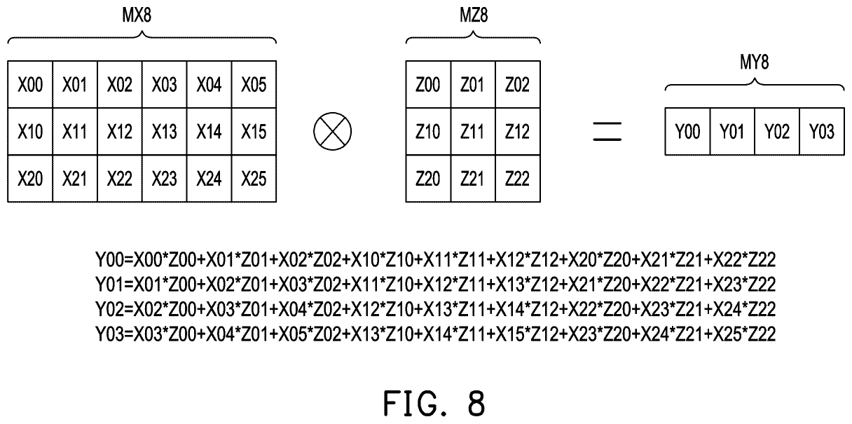

FIG. 8 is a schematic diagram of a convolution operation according to another application example.

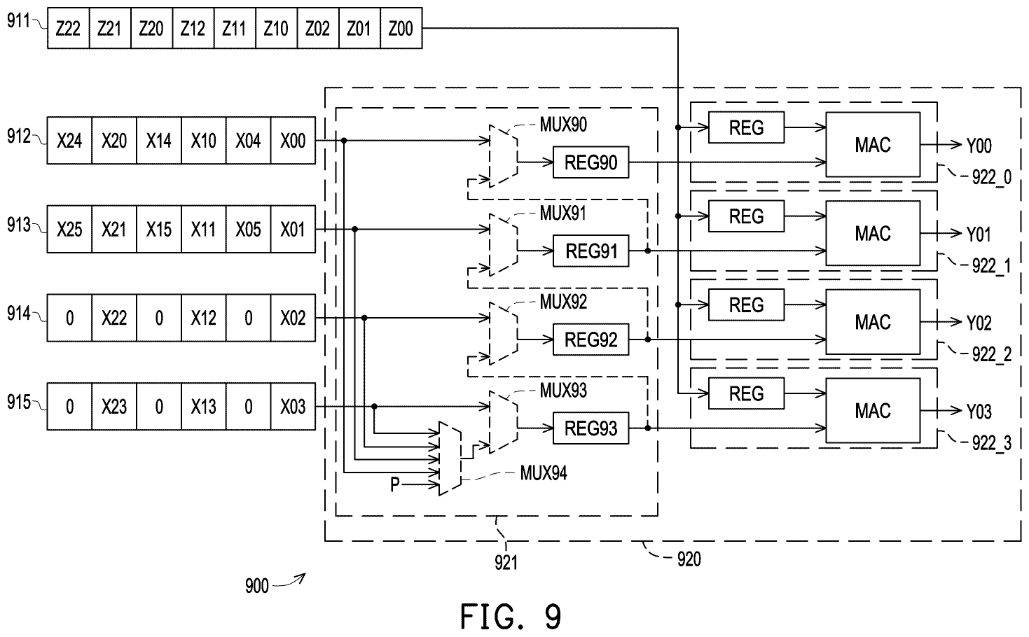

FIG. 9 is a schematic circuit block diagram of a convolution operation device according to yet another embodiment.

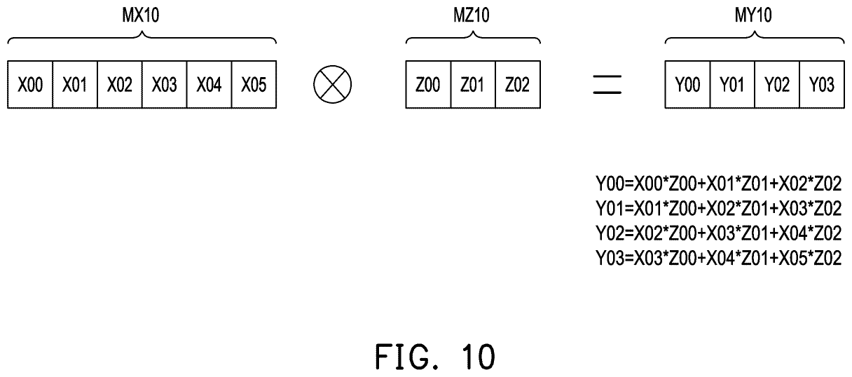

FIG. 10 is a schematic diagram of a convolution operation according to another application example.

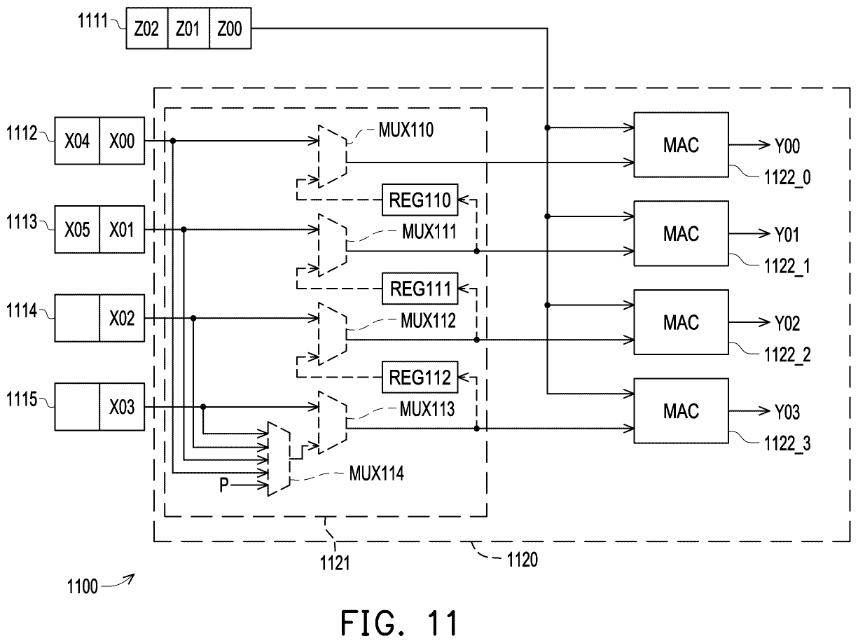

FIG. 11 is a schematic circuit block diagram of a convolution operation device according to yet another embodiment.

### DESCRIPTION OF THE EMBODIMENTS

A term “couple” used in the full text of the disclosure (including the claims) refers to any direct and indirect connections. For example, if a first device is described to be coupled to a second device, it is interpreted as that the first device is directly coupled to the second device, or the first device is indirectly coupled to the second device through other devices or connection means. “First”, “second”, etc., mentioned in the specification and the claims are merely used to name discrete components and should not be regarded as limiting the upper or lower bound of the number of the components, nor is it used to define a manufacturing order or setting order of the components. Moreover, wherever possible, components/members/steps using the same referential numbers in the drawings and description refer to the same or like parts. Components/members/steps using the same referential numbers or using the same terms in different embodiments may cross-refer related descriptions.

FIG. 1 is a schematic circuit block diagram of a convolution operation device 200 according to an embodiment of the invention. Based on control of a host device 100, the convolution operation device 200 may perform various neural network model operations (for example, convolution operations). In the embodiment shown in FIG. 1, the convolution operation device 200 includes a memory 210 and a convolution operation circuit 220. The host device 100 may store a convolution kernel of a trained neural network model in the memory 210 for the use of the convolution operation circuit 220. The convolution operation circuit 220 is coupled to the memory 210. Based on the content of the memory 210, the convolution operation circuit 220 may perform a convolution operation to obtain an operation result matrix.

FIG. 2 is a schematic diagram of a convolution operation according to an application example. In the embodiment shown in FIG. 2, it is assumed that elements of a matrix MX2 include X00, X01, X02 and X03, elements of a convolution kernel MZ2 include Z00, Z01, Z02 and Z03, a stride parameter of the convolution operation is 1, and a padding parameter of the convolution operation is 3 (i.e., the matrix MX2 is additionally padded with 3 padding elements P). A specific value of a padding element P may be defined according to actual applications. For example, the padding element P may be 0 or other real numbers.

Referring to FIG. 1 and FIG. 2, the memory 210 is configured to store the matrix MX2 and the convolution kernel MZ2. Based on the content of the memory 210, the convolution operation circuit 220 may perform a convolution operation to obtain an operation result matrix MY2. In the embodiment shown in FIG. 2, since the matrix MX2 is additionally padded with three padding elements P, the operation result matrix MY2 is a 1*4 matrix (its elements include Y00, Y01, Y02 and Y03, as shown in FIG. 2).

FIG. 3 is a schematic circuit block diagram of a convolution operation device 300 according to an embodiment of the invention. The convolution operation device 300 shown in FIG. 3 includes a memory 311, a memory 312, a memory 313, a memory 314, a memory 315 and a convolution operation circuit 320. The convolution operation circuit 320 shown in FIG. 3 may be used as one of many implementations of the convolution operation circuit 220 shown in FIG. 1. The memories 311 to 315 shown in FIG. 3 may be used as one of many implementations of the memory 210 shown in FIG. 1. In the embodiment shown in FIG. 3, the convolution operation circuit 320 includes 4 multiply-accumulate (MAC) operators and 8 registers (REG). The embodiment does not limit the specific implementations of the MAC operator and the register. For example, the MAC operators may be conventional MAC operators or other multiply-accumulate circuits, and the registers may be conventional registers or other data temporary storage circuits.

Referring to FIG. 2 and FIG. 3, the elements Z00, Z01, Z02 and Z03 of the convolution kernel MZ2 are stored in the memory 311. In order to improve the efficiency of the convolution operation, in the embodiment shown in FIG. 3, the multiple elements of the matrix MX2 will be copied multiple times and stored in different memories 312-315 corresponding to different MAC operators. As shown in FIG. 3, the elements X00, X01, X02 and X03 of the matrix MX2 are stored in the memory 312, the elements X01, X02 and X03 of the matrix MX2 and one padding element P are stored in the memory 313, the elements X02 and X03 of the matrix MX2 and two padding elements P are stored in the memory 314, and the element X03 of the matrix MX2 and three padding elements P are stored in the memory 315.

During a first period, the memories 312 to 315 respectively provide the first elements X00, X01, X02 and X03 to the different MAC operators, and the memory 311 provides the first element Z00 to these four MAC operations. Therefore, after the MAC operation of the first period is completed, the element Y00 is X00*Z00, the element Y01 is X01*Z00, the element Y02 is X02*Z00, and the element Y03 is X03*Z00.

During a second period, the memories 312 to 315 respectively provide the second elements X01. X02. X03 and P to the different MAC operators, and the memory 311 provides the second element Z01 to these four MAC operators. Therefore, after the MAC operation of the second period is completed, the element Y00 is X00*Z00+X01*Z01, the element Y01 is X01*Z00+X02*Z01, the element Y02 is X02*Z00+X03*Z01, and the element Y03 is X03*Z00+p*Z01.

During a third period, the memories 312 to 315 respectively provide the third elements X02, X03, P and P to the different MAC operators, and the memory 311 provides the third element Z02 to these four MAC operators. Therefore, after the MAC operation in the third period is completed, the element Y00 is X00*Z00+X01*Z01+X02*Z02, the element Y01 is X01*Z00+X02*Z01+X03*Z02, the element Y02 is X02*Z00+X03*Z01+p*Z02, and the element Y03 is X03*Z00+p*Z01+p*Z02.

During a fourth period, the memories 312 to 315 respectively provide the fourth elements X03. P, P and P to the different MAC operators, and the memory 311 provides the fourth element Z03 to these four MAC operators. Therefore, after the MAC operation of the fourth period is completed, the element Y00 is X00*Z00+X01*Z01+X02*Z02+X03*Z03, the element Y01 is X01*Z00+X02*Z01+X03*Z02+p*Z03, the element Y02 is X02*Z00+X03*Z01+p*Z02+p*Z03, and the element Y03 is X03*Z00+p*Z01+p*Z02+p*Z03.

In order to improve the efficiency of the convolution operation, as shown in FIG. 3, a plurality of elements of the matrix MX2 may be copied by multiple times and stored in different memories 312-315 corresponding to the different MAC operators. For example, the element X03 of the matrix MX2 is copied in the memories 312 to 315. It is conceivable that to copy the same element data in different memories may affect the memory usage efficiency. The following embodiments illustrate a convolution operation device with efficient memory storage.

FIG. 4 is a schematic circuit block diagram of a convolution operation device 400 according to an embodiment of the invention. The convolution operation device 400 shown in FIG. 4 includes a memory 411, a memory 412, a memory 413, a memory 414, a memory 415 and a convolution operation circuit 420. The memories 411 to 415 shown in FIG. 4 may be used as one of many implementations of the memory 210 shown in FIG. 1. Referring to FIG. 2 and FIG. 4, the elements Z00, Z01, Z02 and Z03 of the convolution kernel MZ2 are stored in the memory 411. The element X00 (a first part) of the matrix MX2 is stored in the memory 412, the element X01 (a second part) of the matrix MX2 is stored in the memory 413, the element X02 (a third part) of the matrix MX2 is stored in the memory 414, and the element X03 (a fourth part) of the matrix MX2 is stored in the memory 415. The partial matrices stored in different memories are mutually exclusive. Namely, any element of the matrix MX2 will not be repeatedly placed in different memories. The different parts of the matrix MX2 are stored in different memories 412-415 to avoid redundant storage of element data.

The convolution operation circuit 420 shown in FIG. 4 may be used as one of many implementations of the convolution operation circuit 220 shown in FIG. 1. In the embodiment shown in FIG. 4, the convolution operation circuit 420 includes a routing and shift register circuit 421 and a plurality of multiply-accumulate circuits. A specific number of the multiply-accumulate circuits may be determined according to an actual design. In the embodiment shown in FIG. 4, the convolution operation circuit 420 includes four multiply-accumulate circuits 422_0, 422_1, 422_2, and 422_3. The multiply-accumulate circuits 422_0-422_3 are coupled to the memory 411 to access the convolution kernel MZ2. The multiply-accumulate circuit 422_0 corresponds to the memory 412, the multiply-accumulate circuit 422_1 corresponds to the memory 413, the multiply-accumulate circuit 422_2 corresponds to the memory 414, and the multiply-accumulate circuit 422_3 corresponds to the memory 415.

The multiply-accumulate circuits 422_0-422_3 have similar circuit structures. Taking the multiply-accumulate circuit 422_0 as an example, the multiply-accumulate circuit 422_0 includes one multiply-accumulate (MAC) operator and one register (REG). In the multiply-accumulate circuit 422_0, an input terminal of the register is coupled to the memory 411, a first input terminal of the MAC operator is coupled to an output terminal of the register, and a second input terminal of the MAC operator is coupled to the routing and shift register circuit 421. For the MAC operators in the multiply-accumulate circuits 422_0 to 422_3, reference may be made to the relevant description of the MAC operators shown in FIG. 3 for analogy, and details thereof will not be repeated.

The routing and shift register circuit 421 is coupled to the memories 412-415 and the multiply-accumulate circuits 422_0-422_3. During the first period, the routing and shift register circuit 421 transmits the element X00 of the memory 412 to the multiply-accumulate circuit 422_0, the routing and shift register circuit 421 transmits the element X01 of the memory 413 to the multiply-accumulate circuit 422_1, the routing and shift register circuit 421 transmits the element X02 of the memory 414 to the multiply-accumulate circuit 422_2, the routing and shift register circuit 421 transmits the element X03 of the memory 415 to the multiply-accumulate circuit 422_3, and the memory 411 provides the first element Z00 to the multiply-accumulate circuits 422_0-422_3. Therefore, after the MAC operation of the first period is completed, the element Y00 is X00*Z00, the element Y01 is X01*Z00, the element Y02 is X02*Z00, and the element Y03 is X03*Z00.

During the second period, the memory 411 provides the second element Z01 to the multiply-accumulate circuits 422_0-422_3, and the routing and shift register circuit 421 transmits the element X01 of the memory 413 to the multiply-accumulate circuit 422_0, the routing and shift register circuit 421 transmits the element X02 of the memory 414 to the multiply-accumulate circuit 422_1, the routing and shift register circuit 421 transmits the element X03 of the memory 415 to the multiply-accumulate circuit 422_2, and the routing and shift register circuit 421 transmits the padding element P to the multiply-accumulate circuit 422_3. A specific value of the padding element P may be defined according to actual applications. For example, the padding element P may be 0 or other real numbers. Therefore, after the MAC operation of the second period is completed, the element Y00 is X00*Z00+X01*Z01, the element Y01 is X01*Z00+X02*Z01, the element Y02 is X02*Z00+X03*Z01, and the element Y03 is X03*Z00+p*Z01.

During the third period, the memory 411 provides the third element Z02 to the multiply-accumulate circuits 422_0-422_3, and the routing and shift register circuit 421 transmits the element X02 of the memory 414 to the multiply-accumulate circuit 422_0, the routing and shift register circuit 421 transmits the element X03 of the memory 415 to the multiply-accumulate circuit 422_1, and the routing and shift register circuit 421 transmits the padding element P to the multiply-accumulate circuits 422_2 and 422_3. Therefore, after the MAC operation of the third period is completed, the element Y00 is X00*Z00+X01*Z01+X02*Z02, the element Y01 is X01*Z00+X02*Z01+X03*Z02, the element Y02 is X02*Z00+X03*Z01+p*Z02, and the element Y03 is X03*Z00+p*Z01+p*Z02.

During the fourth period, the memory 411 provides the fourth element Z03 to the multiply-accumulate circuits 422_0-422_3, and the routing and shift register circuit 421 transmits the element X03 of the memory 415 to the multiply-accumulate circuit 422_0, and the routing and shift register circuit 421 transmits the padding element P to the multiply-accumulate circuits 422_1, 422_2 and 422_3. Therefore, after the MAC operation of the fourth period is completed, the element Y00 is X00*Z00+X01*Z01+X02*Z02+X03*Z03, the element Y01 is X01*Z00+X02*Z01+X03*Z02+p*Z03, the element Y02 is X02*Z00+X03*Z01+p*Z02+p*Z03, and the element Y03 is X03*Z00+p*Z01+p*Z02+p*Z03.

In conclusion, different parts of the matrix MX2 are stored in different memories 412-415 to avoid redundant storage of element data. For the calculation of a certain multiply-accumulate circuit (for example, 422_0), when the required target element (for example, X01) is not in the corresponding memory (for example, 412), the routing and shift register circuit 421 may retrieve this target element from the memory (such as 413) corresponding to another multiply-accumulate circuit (such as 422_1) and transmit it to the certain multiply-accumulate circuit (such as 422-0). Therefore, the convolution operation device 400 provides a hardware computing framework that improves memory efficiency.

This embodiment does not limit the specific implementation of the routing and shift register circuit 421. For example, in the embodiment shown in FIG. 4, the routing and shift register circuit 421 includes a multiplexer MUX40, a register REG40, a multiplexer MUX41, a register REG41, a multiplexer MUX42, a register REG42, multiplexer MUX43 and register REG43. The embodiment does not limit the specific implementations of the multiplexers MUX40-MUX43 and the registers REG40-REG43. For example, the multiplexers MUX40-MUX43 may be conventional multiplexers or other data routing circuits, and the registers REG40-REG43 may be conventional registers or other data temporary storage circuits.

An input terminal of the multiplexer MUX40 is coupled to the memory 412. An input terminal of the register REG40 is coupled to an output terminal of the multiplexer MUX40. An output terminal of the register REG40 is coupled to the multiply-accumulate circuit 422_0. An input terminal of the multiplexer MUX41 is coupled to the memory 413. An input terminal of the register REG41 is coupled to an output terminal of the multiplexer MUX41. An output terminal of the register REG41 is coupled to another input terminal of the multiplexer MUX40 and the multiply-accumulate circuit 422_1. An input terminal of the multiplexer MUX42 is coupled to memory 414. An input terminal of the register REG42 is coupled to an output terminal of the multiplexer MUX42. An output terminal of the register REG42 is coupled to another input terminal of the multiplexer MUX41 and the multiply-accumulate circuit 422_2. An input terminal of the multiplexer MUX43 is coupled to the memory 415. An input terminal of the register REG43 is coupled to an output terminal of the multiplexer MUX43. An output terminal of the register REG43 is coupled to another input terminal of the multiplexer MUX42 and the multiply-accumulate circuit 422_3. Another input terminal of the multiplexer MUX43 receives the padding element P.

During the first period, the multiplexer MUX40 transmits the element X00 of the memory 412 to the register REG40, the multiplexer MUX41 transmits the element X01 of the memory 413 to the register REG41, the multiplexer MUX42 transmits the element X02 of the memory 414 to the register REG42, and the multiplexer MUX43 transmits the element X03 of the memory bank 415 to the register REG43. During the second period, the multiplexer MUX40 transmits the output of the register REG41 (element X01) to the register REG40, the multiplexer MUX41 transmits the output of the register REG42 (element X02) to the register REG41, the multiplexer MUX42 transmits the output of the register REG43 (element X03) to the register REG42, and the multiplexer MUX43 transmits the padding element P to the register REG43. During the third period, the multiplexer MUX40 transmits the output of the register REG41 (element X02) to the register REG40, the multiplexer MUX41 transmits the output of register REG42 (element X03) to the register REG41, the multiplexer MUX42 transmits the output of the register REG43 (padding element P) to the register REG42, and the multiplexer MUX43 transmits the padding element P to the register REG43. During the fourth period, the multiplexer MUX40 transmits the output of the register REG41 (element X03) to the register REG40, the multiplexer MUX41 transmits the output of the register REG42 (padding element P) to the register REG41, the multiplexer MUX42 transmits the output of register REG43 (padding element P) to the register REG42, and the multiplexer MUX43 transmits the padding element P to the register REG43.

FIG. 5 is a schematic diagram of a convolution operation according to another application example. In the embodiment shown in FIG. 5, it is assumed that elements of a matrix MX5 include X00, X01, X02, X03, X04, X05, X06, X07. X08 and X09, elements of a convolution kernel MZ5 include Z00, Z01, Z02 and Z03, a stride parameter of the convolution operation is 2, and a padding parameter of the convolution operation is 0. A number of elements of the matrix MX5 and the convolution kernel MZ5 may be any real number determined according to the actual application. Referring to FIG. 1 and FIG. 5, the memory 210 is used to store the matrix MX5 and the convolution kernel MZ5. Based on the content of the memory 210, the convolution operation circuit 220 may perform a convolution operation to obtain an operation result matrix MY5. Elements of the operation result matrix MY5 include Y00, Y01, Y02 and Y03.

FIG. 6 is a schematic circuit block diagram of a convolution operation device 600 according to another embodiment. The convolution operation device 600 shown in FIG. 6 includes a memory 611, a memory 612, a memory 613, a memory 614, a memory 615 and a convolution operation circuit 620. The memories 611-615 shown in FIG. 6 may be used as one of many implementations of the memory 210 shown in FIG. 1. Referring to FIG. 5 and FIG. 6, the elements Z00-Z03 of the convolution kernel MZ5 are stored in the memory 611. The elements X00, X04, and X08 (first part) of the matrix MX5 are stored in the memory 612, the elements X01, X05, and X09 (second part) of the matrix MX5 are stored in the memory 613, the elements X02 and X06 (third part) of the matrix MX5 are stored in the memory 614, and the elements X03 and X07 (fourth part) of the matrix MX5 are stored in the memory 615. The different parts of the matrix MX5 are stored in different memories 612-615 to avoid redundant storage of element data.

The convolution operation circuit 620 shown in FIG. 6 may be used as one of many implementations of the convolution operation circuit 220 shown in FIG. 1. In the embodiment shown in FIG. 6, the convolution operation circuit 620 includes a routing and shift register circuit 621 and a plurality of multiply-accumulate circuits, such as multiply-accumulate circuits 622_0, 622_1, 622_2, and 622_3. The multiply-accumulate circuits 622_0-622_3 are coupled to the memory 611 to access the convolution kernel MZ5. The multiply-accumulate circuit 622_0 corresponds to the memory 612, the multiply-accumulate circuit 622_1 corresponds to the memory 613, the multiply-accumulate circuit 622_2 corresponds to the memory 614, and the multiply-accumulate circuit 622_3 corresponds to the memory 615. For the multiply-accumulate circuits 622_0-622_3 and the routing and shift register circuit 621 shown in FIG. 6, reference may be made to the relevant descriptions of the multiply-accumulate circuits 422_0-422_3 and the routing and shift register circuit 421 shown in FIG. 4 for analogy, and details thereof are not repeated.

In the embodiment shown in FIG. 6, the routing and shift register circuit 621 includes a multiplexer MUX60, a register REG60, a multiplexer MUX61, a register REG61, a multiplexer MUX62, a register REG62, multiplexer MUX63, register REG63, a multiplexer MUX64 and a multiplexer MUX65. The embodiment does not limit the specific implementations of the multiplexers MUX60-MUX65 and the registers REG60-REG63. For example, the multiplexers MUX60-MUX65 may be conventional multiplexers or other data routing circuits, and the registers REG60-REG63 may be conventional registers or other data temporary storage circuits.

An input terminal of the multiplexer MUX60 is coupled to the memory 612. An input terminal of the register REG60 is coupled to an output terminal of the multiplexer MUX60. An output terminal of the register REG60 is coupled to the multiply-accumulate circuit 622_0. An input terminal of the multiplexer MUX61 is coupled to the memory 613. An input terminal of the register REG61 is coupled to an output terminal of the multiplexer MUX61. An output terminal of the register REG61 is coupled to another input terminal of the multiplexer MUX60 and the multiply-accumulate circuit 622_1. An input terminal of the multiplexer MUX62 is coupled to the memory 614. An input terminal of the register REG62 is coupled to an output terminal of the multiplexer MUX62. An output terminal of the register REG62 is coupled to another input terminal of the multiplexer MUX60, another input terminal of the multiplexer MUX61 and the multiply-accumulate circuit 622_2. An input terminal of the multiplexer MUX63 is coupled to the memory 615. An input terminal of the register REG63 is coupled to an output terminal of the multiplexer MUX63. An output terminal of the register REG63 is coupled to another input terminal of the multiplexer MUX61, another input terminal of the multiplexer MUX62 and the multiply-accumulate circuit 622_3. Another input terminal of the multiplexer MUX63 is coupled to the output terminal of the multiplexer MUX64.

Different input terminals of the multiplexer MUX64 are respectively coupled to the memory 612, the memory 613, the memory 614, the memory 615 and the padding element P (for example, 0 or other real numbers). Different input terminals of the multiplexer MUX65 are respectively coupled to the memory 612, the memory 613, the memory 614, the memory 615 and the padding element P. An output terminal of the multiplexer MUX65 is coupled to another input terminal of the multiplexer MUX62.

During the first period, the memory 611 provides the element Z00 to the multiply-accumulate circuits 622_0-622_3, the element X00 of the memory 612 is transmitted to the multiply-accumulate circuit 622_0 through the multiplexer MUX60 and the register REG60, the element X01 of the memory 613 is transmitted to the register REG61 through the multiplexer MUX61, the element X02 of the memory 614 is transmitted to the multiply-accumulate circuit 622_2 through the multiplexer MUX62 and the register REG62, and the element X03 of the memory 615 is transmitted to the register REG63 through the multiplexer MUX63. Therefore, after the MAC operation of the first period is completed, the element Y00 is X00*Z00, and the element Y01 is X02*Z00. During the first period, the multiply-accumulate circuits 622_1 and 622_3 are idle, i.e., gated.

During the second period, the memory 611 provides the element Z02 to the multiply-accumulate circuits 622_0-622_3, and the element X02 of the register REG62 is transmitted to the multiply-accumulate circuit 622_0 through the multiplexer MUX60 and the register REG60, and the element X04 of the memory 612 is transmitted to the multiply-accumulate circuit 622_2 through the multiplexer MUX65, the multiplexer MUX62 and the register REG62. Therefore, after the MAC operation of the second period is completed, the element Y00 is X00*Z00+X02*Z02, and the element Y01 is X02*Z00+X04*Z02. During the second period, the multiply-accumulate circuits 622_1 and 622_3 are idle.

During the third period, the memory 611 provides the element Z01 to the multiply-accumulate circuits 622_0-622_3, the element X01 of the register REG61 is transmitted to the multiply-accumulate circuit 622_0 through the multiplexer MUX60 and the register REG60, and the element X03 of the register REG63 is transmitted to the multiply-accumulate circuit 622_2 through the multiplexer MUX62 and the register REG62. Therefore, after the MAC operation of the third period is completed, the element Y00 is X00*Z00+X01*Z01+X02*Z02, and the element Y01 is X02*Z00+X03*Z01+X04*Z02. During the third period, the multiply-accumulate circuits 622_1 and 622_3 are idle.

During the fourth period, the memory 611 provides the element Z03 to the multiply-accumulate circuits 622_0-622_3, the element X03 of the temporary register REG62 is transmitted to the multiply-accumulate circuit 622_0 through the multiplexer MUX60 and the register REG60, the element X05 of the memory 613 is transmitted to the multiply-accumulate circuit 622_2 through the multiplexer MUX65, the multiplexer MUX62 and the register REG62, and the element X04 of the memory 612 is transmitted to the register REG63 through the multiplexers MUX64 and MUX63. Therefore, after the MAC operation of the fourth period is completed, the element Y00 is X00*Z00+X01*Z01+X02*Z02+X03*Z03, and the element Y01 is X02*Z00+X03*Z01+X04*Z02+X05*Z03. During the fourth period, the multiply-accumulate circuits 622_1 and 622_3 are idle.

During a fifth period, the memory 611 provides the element Z00 to the multiply-accumulate circuits 622_0-622_3, the element X04 of the register REG63 is transmitted to the multiply-accumulate circuit 622_1 through the multiplexer MUX61 and the register REG61, and the element X06 of the memory 614 is transmitted to the multiply-accumulate circuit 622_3 through the multiplexer MUX64, the multiplexer MUX63 and the register REG63. Therefore, after the MAC operation of the fifth period is completed, the element Y02 is X04*Z00, and the element Y03 is X06*Z00. During the fifth period, the multiply-accumulate circuits 622_0 and 622_2 are gated, so that the element Y00 remains as X00*Z00+X01*Z01+X02*Z02+X03*Z03, and the element Y01 remains as X02*Z00+X03*Z01+X04*Z02+X05*Z03.

During a sixth period, the memory 611 provides the element Z02 to the multiply-accumulate circuits 622_0-622_3, the element X06 of the register REG63 is transmitted to the multiply-accumulate circuit 622_1 through the multiplexer MUX61 and the register REG61, and the element X08 of the memory 612 is transmitted to the multiply-accumulate circuit 622_3 through the multiplexer MUX64, the multiplexer MUX63 and the register REG63. Therefore, after the MAC operation of the sixth period is completed, the element Y02 is X04*Z00+X06*Z02, and the element Y03 is X06*Z00+X08*Z02. In the sixth period, the multiply-accumulate circuits 622_0 and 622_2 are gated.

During a seventh period, the memory 611 provides the element Z01 to the multiply-accumulate circuits 622_0-622_3, the element X05 of the memory 613 is transmitted to the multiply-accumulate circuit 622_1 through the multiplexer MUX61 and the register REG61, and the element X07 of the memory 615 is transmitted to the multiply-accumulate circuit 622_3 through the multiplexer MUX63 and the register REG63. Therefore, after the MAC operation of the seventh period is completed, the element Y02 is X04*Z00+X05*Z01+X06*Z02, and the element Y03 is X06*Z00+X07*Z01+X08*Z02. In the seventh period, the multiply-accumulate circuits 622_0 and 622_2 are gated.

During an eighth period, the memory 611 provides the element Z03 to the multiply-accumulate circuits 622_0-622_3, the element X07 of the register REG63 is transmitted to the multiply-accumulate circuit 622_1 through the multiplexer MUX61 and the register REG61, and the element X09 of the memory 613 is transmitted to the multiply-accumulate circuit 622_3 through the multiplexer MUX64, the multiplexer MUX63 and the register REG63. Therefore, after the MAC operation of the eighth period is completed, the element Y02 is X04*Z00+X05*Z01+X06*Z02+X07*Z03, and the element Y03 is X06*Z00+X07*Z01+X08*Z02+X09*Z03. During the eighth period, the multiply-accumulate circuits 622_0 and 622_2 are gated.

FIG. 7 is a schematic circuit block diagram of a convolution operation device 700 according to still another embodiment. The convolution operation device 700 shown in FIG. 7 includes a memory 711, a memory 712, a memory 713, a memory 714, a memory 715 and a convolution operation circuit 720. The memories 711-715 shown in FIG. 7 may be used as one of many implementations of the memory 210 shown in FIG. 1. Referring to FIG. 5 and FIG. 7, the elements Z00 to Z03 of the convolution kernel MZ5 are stored in the memory 711. The elements X00, X01, X08 and X09 (the first part) of the matrix MX5 are stored in the memory 712, the elements X02 and X03 (the second part) of the matrix MX5 are stored in the memory 713, the elements X04 and X05 (the third part) of the matrix MX5 are stored in the memory 714, and the elements X06 and X07 (the fourth part) of the matrix MX5 are stored in the memory 715. The different parts of the matrix MX5 are stored in the different memories 712-715 to avoid redundant storage of element data.

The convolution operation circuit 720 shown in FIG. 7 may be used as one of many implementations of the convolution operation circuit 220 shown in FIG. 1. In the embodiment shown in FIG. 7, the convolution operation circuit 720 includes a routing and shift register circuit 721 and a plurality of multiply-accumulate circuits, such as multiply-accumulate circuits 722_0, 722_1, 722_2, and 722_3. The multiply-accumulate circuits 722_0-722_3 are coupled to the memory 711 to access the convolution kernel MZ5. The multiply-accumulate circuit 722_0 corresponds to the memory 712, the multiply-accumulate circuit 722_1 corresponds to the memory 713, the multiply-accumulate circuit 722_2 corresponds to the memory 714, and the multiply-accumulate circuit 722_3 corresponds to the memory 715. For the multiply-accumulate circuits 722_0-722_3 and the routing and shift register circuit 721 shown in FIG. 7, reference may be made to the relevant descriptions of the multiply-accumulate circuits 422_0-422_3 and the routing and shift register circuit 421 shown in FIG. 4 for analogy, and details thereof are not repeated.

In the embodiment shown in FIG. 7, the routing and shift register circuit 721 includes a multiplexer MUX70, a register REG70, a multiplexer MUX71, a register REG71, a multiplexer MUX72, a register REG72, a multiplexer MUX73, a register REG73 and a multiplexer MUX74. The embodiment does not limit the specific implementations of the multiplexers MUX70-MUX74 and the registers REG70-REG73. For example, the multiplexers MUX70-MUX74 may be conventional multiplexers or other data routing circuits, and the registers REG70-REG73 may be conventional registers or other data temporary storage circuits.

An input terminal of the multiplexer MUX70 is coupled to the memory 712. An input terminal of the register REG70 is coupled to an output terminal of the multiplexer MUX70. An output terminal of the register REG70 is coupled to the multiply-accumulate circuit 722_0. An input terminal of the multiplexer MUX71 is coupled to the memory 713. An input terminal of the register REG71 is coupled to an output terminal of the multiplexer MUX71. An output terminal of the register REG71 is coupled to another input terminal of the multiplexer MUX70 and the multiply-accumulate circuit 722_1. An input terminal of the multiplexer MUX72 is coupled to the memory 714. An input terminal of the register REG72 is coupled to an output terminal of the multiplexer MUX72. An output terminal of the register REG72 is coupled to another input terminal of the multiplexer MUX71 and the multiply-accumulate circuit 722_2. An input terminal of the multiplexer MUX73 is coupled to the memory 715. An input terminal of the register REG73 is coupled to an output terminal of the multiplexer MUX73. An output terminal of the register REG73 is coupled to another input terminal of the multiplexer MUX72 and the multiply-accumulate circuit 722_3. Another input terminal of the multiplexer MUX73 is coupled to an output terminal of the multiplexer MUX74. Different input terminals of the multiplexer MUX74 are respectively coupled to the memory 712, the memory 713, the memory 714, the memory 715 and the padding element P (such as 0 or other real numbers).

During the first period, the memory 711 provides the element Z00 to the multiply-accumulate circuits 722_0-722_3. The element X00 of the memory 712 is transmitted to the multiply-accumulate circuit 722_0 through the multiplexer MUX70 and the register REG70, the element X02 of the memory 713 is transmitted to the multiply-accumulate circuit 722_1 through the multiplexer MUX71 and the register REG71, the element X04 of the memory 714 is transmitted to the multiply-accumulate circuit 722_2 through the multiplexer MUX72 and the register REG72, and the element X06 of the memory 715 is transmitted to the multiply-accumulate circuit 722_3 through the multiplexer MUX73 and the register REG73. Therefore, after the MAC operation of the first period is completed, the element Y00 is X00*Z00, the element Y01 is X02*Z00, the element Y02 is X04*Z00, and the element Y03 is X06*Z00.

During the second period, the memory 711 provides the element Z02 to the multiply-accumulate circuits 722_0-722_3. The element X02 of the register REG71 is transmitted to the multiply-accumulate circuit 722_0 through the multiplexer MUX70 and the register REG70, the element X04 of the register REG72 is transmitted to the multiply-accumulate circuit 722_1 through the multiplexer MUX71 and the register REG71, the element X06 of the register REG73 is transmitted to the multiply-accumulate circuit 722_2 through the multiplexer MUX72 and the register REG72, and the element X08 of the memory 712 is transmitted to the multiply-accumulate circuit 722_3 through the multiplexer MUX74, the multiplexer MUX73 and the register REG73. Therefore, after the MAC operation of the second period is completed, the element Y00 is X00*Z00+X02*Z02, the element Y01 is X02*Z00+X04*Z02, the element Y02 is X04*Z00+X06*Z02, and the element Y03 is X06*Z00+X08*Z02.

During the third period, the memory 711 provides the element Z01 to the multiply-accumulate circuits 722_0-722_3. The element X01 of the memory 712 is transmitted to the multiply-accumulate circuit 722_0 through the multiplexer MUX70 and the register REG70, the element X03 of the memory 713 is transmitted to the multiply-accumulate circuit 722_1 through the multiplexer MUX71 and the register REG71, the element X05 of the memory 714 is transmitted to the multiply-accumulate circuit 722_2 through the multiplexer MUX72 and the register REG72, and the element X07 of the memory 715 is transmitted to the multiply-accumulate circuit 722_3 through the multiplexer MUX73 and the register REG73. Therefore, after the MAC operation of the third period is completed, the element Y00 is X00*Z00+X01*Z01+X02*Z02, the element Y01 is X02*Z00+X03*Z01+X04*Z02, the element Y02 is X04*Z00+X05*Z01+X06*Z02, and the element Y03 is X06*Z00+X07*Z01+X08*Z02.

During the fourth period, the memory 711 provides the element Z03 to the multiply-accumulate circuits 722_0-722_3. The element X03 of the register REG71 is transmitted to the multiply-accumulate circuit 722_0 through the multiplexer MUX70 and the register REG70, the element X05 of the register REG72 is transmitted to the multiply-accumulate circuit 722_1 through the multiplexer MUX71 and the register REG71, the element X07 of the register REG73 is transmitted to the multiply-accumulate circuit 722_2 through the multiplexer MUX72 and the register REG72, and the element X09 of the memory 712 is transmitted to the multiply-accumulate circuit 722_3 through the multiplexer MUX74, the multiplexer MUX73 and the register REG73. Therefore, after the MAC operation of the fourth period is completed, the element Y00 is X00*Z00+X01*Z01+X02*Z02+X03*Z03, the element Y01 is X02*Z00+X03*Z01+X04*Z02+X05*Z03, the element Y02 is X04*Z00+X05*Z01+X06*Z02+X07*Z03, and the element Y03 is X06*Z00+X07*Z01+X08*Z02+X09*Z03.

FIG. 8 is a schematic diagram of a convolution operation according to another application example. In the embodiment shown in FIG. 8, it is assumed that elements of a matrix MX8 include X00, X01, X02, X03, X04, X05, X10, X11, X12, X13, X14, X15, X20, X21, X22, X23, X24 and X25, elements of a convolution kernel MZ8 include Z00, Z01, Z02, Z10, Z11, Z12, Z20, Z21 and Z22, a stride parameter of the convolution operation is 1, and a padding parameter of the convolution operation is 0. A number of elements of the matrix MX8 and the convolution kernel MZ8 may be any real number determined according to the actual application. Referring to FIG. 1 and FIG. 8, the memory 210 is used to store the matrix MX8 and the convolution kernel MZ8. Based on the content of the memory 210, the convolution operation circuit 220 may perform a convolution operation to obtain an operation result matrix MY8. The elements of the operation result matrix MY8 include Y00, Y01, Y02 and Y03.

FIG. 9 is a schematic circuit block diagram of a convolution operation device 900 according to yet another embodiment. The convolution operation device 900 shown in FIG. 9 includes a memory 911, a memory 912, a memory 913, a memory 914, a memory 915 and a convolution operation circuit 920. The memories 911-915 shown in FIG. 9 may be used as one of many implementations of the memory 210 shown in FIG. 1. Referring to FIG. 8 and FIG. 9, the elements Z00-Z22 of the convolution kernel MZ8 are stored in the memory 911. The elements X00, X04, X10, X14, X20 and X24 (first part) of the matrix MX8 are stored in the memory 912, the elements X01, X05, X11, X15, X21 and X25 (second part) of the matrix MX8 are stored in the memory 913, the elements X02, X12 and X22 (third part) of the matrix MX8 are stored in the memory 914, and the elements X03, X13 and X23 (fourth part) of the matrix MX8 are stored in the memory 915. The different parts of the matrix MX8 are stored in the different memories 912-915 to avoid redundant storage of element data.

The convolution operation circuit 920 shown in FIG. 9 may be used as one of many implementations of the convolution operation circuit 220 shown in FIG. 1. In the embodiment shown in FIG. 9, the convolution operation circuit 920 includes a routing and shift register circuit 921 and a plurality of multiply-accumulate circuits, such as multiply-accumulate circuits 922_0, 922_1, 922_2, and 922_3. The multiply-accumulate circuits 922_0-922_3 are coupled to the memory 911 to access the convolution kernel MZ8. The multiply-accumulate circuit 922_0 corresponds to the memory 912, the multiply-accumulate circuit 922_1 corresponds to the memory 913, the multiply-accumulate circuit 922_2 corresponds to the memory 914, and the multiply-accumulate circuit 922_3 corresponds to the memory 915. For the multiply-accumulate circuits 922_0-922_3 and the routing and shift register circuit 921 shown in FIG. 9, reference may be made to the relevant descriptions of the multiply-accumulate circuits 422_0-422_3 and the routing and shift register circuit 421 shown in FIG. 4 for analogy, and details thereof are not repeated.

In the embodiment shown in FIG. 9, the routing and shift register circuit 921 includes a multiplexer MUX90, a register REG90, a multiplexer MUX91, a register REG91, a multiplexer MUX92, a register REG92, a multiplexer MUX93, a register REG93 and a multiplexer MUX94. The embodiment does not limit the specific implementations of the multiplexers MUX90-MUX94 and the registers REG90-REG93. For example, the multiplexers MUX90-MUX94 may be conventional multiplexers or other data routing circuits, and the registers REG90-REG93 may be conventional registers or other data temporary storage circuits.

An input terminal of the multiplexer MUX90 is coupled to the memory 912. An input terminal of the register REG90 is coupled to an output terminal of the multiplexer MUX90. An output terminal of the register REG90 is coupled to the multiply-accumulate circuit 922_0. An input terminal of the multiplexer MUX91 is coupled to the memory 913. An input terminal of the register REG91 is coupled to an output terminal of the multiplexer MUX91. An output terminal of the register REG91 is coupled to another input terminal of the multiplexer MUX90 and the multiply-accumulate circuit 922_1. An input terminal of the multiplexer MUX92 is coupled to the memory 914. An input terminal of the register REG92 is coupled to an output terminal of the multiplexer MUX92. An output terminal of the register REG92 is coupled to another input terminal of the multiplexer MUX91 and the multiply-accumulate circuit 922_2. An input terminal of the multiplexer MUX93 is coupled to the memory 915. An input terminal of the register REG93 is coupled to an output terminal of the multiplexer MUX93. An output terminal of the register REG93 is coupled to another input terminal of the multiplexer MUX92 and the multiply-accumulate circuit 922_3. Another input terminal of the multiplexer MUX93 is coupled to an output terminal of the multiplexer MUX94. Different input terminals of the multiplexer MUX94 are respectively coupled to the memory 912, the memory 913, the memory 914, the memory 915 and the padding element P (such as 0 or other real numbers).

During the first period, the memory 911 provides the element Z00 to the multiply-accumulate circuits 922_0-922_3. The element X00 of the memory 912 is transmitted to the multiply-accumulate circuit 922_0 through the multiplexer MUX90 and the register REG90, the element X01 of the memory 913 is transmitted to the multiply-accumulate circuit 922_1 through the multiplexer MUX91 and the register REG91, the element X02 of the memory 914 is transmitted to the multiply-accumulate circuit 922_2 through the multiplexer MUX92 and the register REG92, and the element X03 of the memory 915 is transmitted to the multiply-accumulate circuit 922_3 through the multiplexer MUX93 and the register REG93. Therefore, after the MAC operation of the first period is completed, the element Y00 is X00*Z00, the element Y01 is X01*Z00, the element Y02 is X02*Z00, and the element Y03 is X03*Z00.

During the second period, the memory 911 provides the element Z01 to the multiply-accumulate circuits 922_0-922_3. The element X01 of the register REG91 is transmitted to the multiply-accumulate circuit 922_0 through the multiplexer MUX90 and the register REG90, the element X02 of the register REG92 is transmitted to the multiply-accumulate circuit 922_1 through the multiplexer MUX91 and the register REG91, the element X03 of the register REG93 is transmitted to the multiply-accumulate circuit 922_2 through the multiplexer MUX92 and the register REG92, and the element X04 of the memory 912 is transmitted to the multiply-accumulate circuit 922_3 through the multiplexer MUX94, the multiplexer MUX93 and the register REG93. Therefore, after the MAC operation of the second period is completed, the element Y00 is X00*Z00+X01*Z01, the element Y01 is X01*Z00+X02*Z01, the element Y02 is X02*Z00+X03*Z01, and the element Y03 is X03*Z00+X04*Z01.

During the third period, the memory 911 provides the element Z02 to the multiply-accumulate circuits 922_0-922_3. The element X02 of the register REG91 is transmitted to the multiply-accumulate circuit 922_0 through the multiplexer MUX90 and the register REG90, the element X03 of the register REG92 is transmitted to the multiply-accumulate circuit 922_1 through the multiplexer MUX91 and the register REG91, the element X04 of the register REG93 is transmitted to the multiply-accumulate circuit 922_2 through the multiplexer MUX92 and the register REG92, and the element X05 of the memory 913 is transmitted to the multiply-accumulate circuit 922_3 through the multiplexer MUX94, the multiplexer MUX93 and the register REG93. Therefore, after the MAC operation of the third period is completed, the element Y00 is X00*Z00+X01*Z01+X02*Z02, the element Y01 is X01*Z00+X02*Z01+X03*Z02, the element Y02 is X02*Z00+X03*Z01+X04*Z02, and the element Y03 is X03*Z00+X04*Z01+X05*Z02.

During the fourth period, the memory 911 provides the element Z10 to the multiply-accumulate circuits 922_0-922_3. The element X10 of the memory 912 is transmitted to the multiply-accumulate circuit 922_0 through the multiplexer MUX90 and the register REG90, the element X11 of the memory 913 is transmitted to the multiply-accumulate circuit 922_1 through the multiplexer MUX91 and the register REG91, the element X12 of the memory 914 is transmitted to the multiply-accumulate circuit 922_2 through the multiplexer MUX92 and the register REG92, and the element X13 of the memory 915 is transmitted to the multiply-accumulate circuit 922_3 through the multiplexer MUX93 and the register REG93. Therefore, after the MAC operation of the fourth period is completed, the element Y00 is X00*Z00+X01*Z01+X02*Z02+X10*Z10, the element Y01 is X01*Z00+X02*Z01+X03*Z02+X11*Z10, the element Y02 is X02*Z00+X03*Z01+X04*Z02+X12*Z10, and the element Y03 is X03*Z00+X04*Z01+X05*Z02+X13*Z10.

During the fifth period, the memory 911 provides the element Z11 to the multiply-accumulate circuits 922_0-922_3. The element X11 of the register REG91 is transmitted to the multiply-accumulate circuit 922_0 through the multiplexer MUX90 and the register REG90, the element X12 of the register REG92 is transmitted to the multiply-accumulate circuit 922_1 through the multiplexer MUX91 and the register REG91, the element X13 of the register REG93 is transmitted to the multiply-accumulate circuit 922_2 through the multiplexer MUX92 and the register REG92, and the element X14 of the memory 912 is transmitted to the multiply-accumulate circuit 922_3 through the multiplexer MUX94, the multiplexer MUX93 and the register REG93. Therefore, after the MAC operation of the fifth period is completed, the element Y00 is X00*Z00+X01*Z01+X02*Z02+X10*Z10+X11*Z11, the element Y01 is X01*Z00+X02*Z01+X03*Z02+X11*Z10+X12*Z11, the element Y02 is X02*Z00+X03*Z01+X04*Z02+X12*Z10+X13*Z11, and the element Y03 is X03*Z00+X04*Z01+X05*Z02+X13*Z10+X14*Z11.

During the sixth period, the memory 911 provides the element Z12 to the multiply-accumulate circuits 922_0-922_3. The element X12 of the register REG91 is transmitted to the multiply-accumulate circuit 922_0 through the multiplexer MUX90 and the register REG90, the element X13 of the register REG92 is transmitted to the multiply-accumulate circuit 922_1 through the multiplexer MUX91 and the register REG91, the element X14 of the register REG93 is transmitted to the multiply-accumulate circuit 922_2 through the multiplexer MUX92 and the register REG92, and the element X15 of the memory 913 is transmitted to the multiply-accumulate circuit 922_3 through the multiplexer MUX94, the multiplexer MUX93 and the register REG93. Therefore, after the MAC operation of the sixth period is completed, the element Y00 is X00*Z00+X01*Z01+X02*Z02+X10*Z10+X11*Z11+X12*Z12, the element Y01 is X01*Z00+X02*Z01+X03*Z02+X11*Z10+X12*Z11+X13*Z12, the element Y02 is X02*Z00+X03*Z01+X04*Z02+X12*Z10+X13*Z11+X14*Z12, and the element Y03 is X03*Z00+X04*Z01+X05*Z02+X13*Z10+X14*Z11+X15*Z12.

During the seventh period, the memory 911 provides the element Z20 to the multiply-accumulate circuits 922_0-922_3. The element X20 of the memory 912 is transmitted to the multiply-accumulate circuit 922_0 through the multiplexer MUX90 and the register REG90, the element X21 of the memory 913 is transmitted to the multiply-accumulate circuit 922_1 through the multiplexer MUX91 and the register REG91, the element X22 of the memory 914 is transmitted to the multiply-accumulate circuit 922_2 through the multiplexer MUX92 and the register REG92, and the element X23 of the memory 915 is transmitted to the multiply-accumulate circuit 922_3 through the multiplexer MUX93 and the register REG93. Therefore, after the MAC operation of the seventh period is completed, the element Y00 is X00*Z00+X01*Z01+X02*Z02+X10*Z10+X11*Z11+X12*Z12+X20*Z20, the element Y01 is X01*Z00+X02*Z01+X03*Z02+X11*Z10+X12*Z11+X13*Z12+X21*Z20, the element Y02 is X02*Z00+X03*Z01+X04*Z02+X12*Z10+X13*Z11+X14*Z12+X22*Z20, and the element Y03 is X03*Z00+X04*Z01+X05*Z02+X13*Z10+X14*Z11+X15*Z12+X23*Z20.

During the eighth period, the memory 911 provides the element Z21 to the multiply-accumulate circuits 922_0-922_3. The element X21 of the register REG91 is transmitted to the multiply-accumulate circuit 922_0 through the multiplexer MUX90 and the register REG90, the element X22 of the register REG92 is transmitted to the multiply-accumulate circuit 922_1 through the multiplexer MUX91 and the register REG91, the element X23 of the register REG93 is transmitted to the multiply-accumulate circuit 922_2 through the multiplexer MUX92 and the register REG92, and the element X24 of the memory 912 is transmitted to the multiply-accumulate circuit 922_3 through the multiplexer MUX94, the multiplexer MUX93 and the register REG93. Therefore, after the MAC operation of the eighth period is completed, the element Y00 is X00*Z00+X01*Z01+X02*Z02+X10*Z10+X11*Z11+X12*Z12+X20*Z20+X21*Z21, the element Y01 is X01*Z00+X02*Z01+X03*Z02+X11*Z10+X12*Z11+X13*Z12+X21*Z20+X22*Z21, the element Y02 is X02*Z00+X03*Z01+X04*Z02+X12*Z10+X13*Z11+X14*Z12+X22*Z20+X232*Z21, and the element Y03 is X03*Z00+X04*Z01+X05*Z02+X13*Z10+X14*Z11+X15*Z12+X23*Z20+X24*Z21.

During the ninth period, the memory 911 provides the element Z22 to the multiply-accumulate circuits 922_0-922_3. The element X22 of the register REG91 is transmitted to the multiply-accumulate circuit 922_0 through the multiplexer MUX90 and the register REG90, the element X23 of the register REG92 is transmitted to the multiply-accumulate circuit 922_1 through the multiplexer MUX91 and the register REG91, the element X24 of the register REG93 is transmitted to the multiply-accumulate circuit 922_2 through the multiplexer MUX92 and the register REG92, and the element X25 of the memory 913 is transmitted to the multiply-accumulate circuit 922_3 through the multiplexer MUX94, the multiplexer MUX93 and the register REG93. Therefore, after the MAC operation of the ninth period is completed, the element Y00 is X00*Z00+X01*Z01+X02*Z02+X10*Z10+X11*Z11+X12*Z12+X20*Z20+X21*Z21+X22*Z22, the element Y01 is X01*Z00+X02*Z01+X03*Z02+X11*Z10+X12*Z11+X13*Z12+X21*Z20+X22*Z21+X23*Z22, the element Y02 is X02*Z00+X03*Z01+X04*Z02+X12*Z10+X13*Z11+X14*Z12+X22*Z20+X23*Z21+X24*Z22, and the element Y03 is X03*Z00+X04*Z01+X05*Z02+X13*Z10+X14*Z11+X15*Z12+X23*Z20+X24*Z21+X25*Z22.

FIG. 10 is a schematic diagram of a convolution operation according to another application example. In the embodiment shown in FIG. 10, it is assumed that elements of a matrix MX10 include X00, X01, X02, X03, X04 and X05, elements of a convolution kernel MZ10 include Z00, Z01, Z02, a stride parameter of the convolution operation is 1, and a padding parameter of the convolution operation is 0. A number of elements of the matrix MX8 and the convolution kernel MZ8 may be any real number determined according to the actual application. Referring to FIG. 1 and FIG. 10, the memory 210 is used to store the matrix MX10 and the convolution kernel MZ10. Based on the content of the memory 210, the convolution operation circuit 220 may perform a convolution operation to obtain an operation result matrix MY10. The elements of the operation result matrix MY10 include Y00, Y01, Y02 and Y03.

FIG. 11 is a schematic circuit block diagram of a convolution operation device 1100 according to yet another embodiment. The convolution operation device 1100 shown in FIG. 11 includes a memory 1111, a memory 1112, a memory 1113, a memory 1114, a memory 1115 and a convolution operation circuit 1120. The memories 1111-1115 shown in FIG. 11 may be used as one of many implementations of the memory 210 shown in FIG. 1. Referring to FIG. 10 and FIG. 11, the elements Z00-Z02 of the convolution kernel MZ10 are stored in the memory 1111. The elements X00 and X04 (first part) of the matrix MX10 are stored in the memory 1112, the elements X01 and X05 (second part) of the matrix MX10 are stored in the memory 1113, the elements X02 (third part) of the matrix MX10 is stored in the memory 1114, and the elements X03 (fourth part) of the matrix MX10 is stored in the memory 1115. The different parts of the matrix MX8 are stored in the different memories 1112-1115 to avoid redundant storage of element data.

The convolution operation circuit 1120 shown in FIG. 11 may be used as one of many implementations of the convolution operation circuit 220 shown in FIG. 1. In the embodiment shown in FIG. 11, the convolution operation circuit 1120 includes a routing and shift register circuit 1121 and a plurality of multiply-accumulate circuits, such as multiply-accumulate circuits 1122_0, 1122_1, 1122_2, and 1122_3. The multiply-accumulate circuits 1122_0-1122_3 are coupled to the memory 1111 to access the convolution kernel MZ10. The multiply-accumulate circuit 1122_0 corresponds to the memory 1112, the multiply-accumulate circuit 1122_1 corresponds to the memory 1113, the multiply-accumulate circuit 1122_2 corresponds to the memory 1114, and the multiply-accumulate circuit 1122_3 corresponds to the memory 1115. For the multiply-accumulate circuits 1122_0-1122_3 and the routing and shift register circuit 1121 shown in FIG. 11, reference may be made to the relevant descriptions of the multiply-accumulate circuits 422_0-422_3 and the routing and shift register circuit 421 shown in FIG. 4 for analogy, and details thereof are not repeated.

In the embodiment shown in FIG. 11, the routing and shift register circuit 1121 includes a multiplexer MUX110, a register REG110, a multiplexer MUX111, a register REG111, a multiplexer MUX112, a register REG112, a multiplexer MUX113 and a multiplexer MUX114. The embodiment does not limit the specific implementations of the multiplexers MUX110-MUX114 and the registers REG110-REG112. For example, the multiplexers MUX110-MUX114 may be conventional multiplexers or other data routing circuits, and the registers REG110-REG112 may be conventional registers or other data temporary storage circuits.

An input terminal of the multiplexer MUX110 is coupled to the memory 1112. An output terminal of the multiplexer MUX110 is coupled to the multiply-accumulate circuit 1122_0. An input terminal of the multiplexer MUX111 is coupled to the memory 1113. An output terminal of the multiplexer MUX111 is coupled to the multiply-accumulate circuit 1122_1. An input terminal of the register REG110 is coupled to an output terminal of the multiplexer MUX111. An output terminal of the register REG110 is coupled to another input terminal of the multiplexer MUX110. An input terminal of the multiplexer MUX112 is coupled to the memory 1114. An output terminal of the multiplexer MUX112 is coupled to the multiply-accumulate circuit 1122_2. An input terminal of the register REG111 is coupled to an output terminal of the multiplexer MUX112. An output terminal of the register REG111 is coupled to another input terminal of the multiplexer MUX111. An input terminal of the multiplexer MUX113 is coupled to the memory 1115. An output terminal of the multiplexer MUX113 is coupled to the multiply-accumulate circuit 1122_3. An input terminal of the register REG112 is coupled to an output terminal of the multiplexer MUX113. An output terminal of the register REG112 is coupled to another input terminal of the multiplexer MUX112. Different input terminals of the multiplexer MUX114 are respectively coupled to the memory 1112, the memory 1113, the memory 1114, the memory 1115 and the padding element P (such as 0 or other real numbers). An output terminal of the multiplexer MUX114 is coupled to another input terminal of the multiplexer MUX113.

During the first period, the memory 1111 provides the element Z00 to the multiply-accumulate circuits 1122_0-1122_3. The element X00 of the memory 1112 is transmitted to the multiply-accumulate circuit 1122_0 through the multiplexer MUX110, the element X01 of the memory 1113 is transmitted to the multiply-accumulate circuit 1122_1 and the register REG110 through the multiplexer MUX111, the element X02 of the memory 1114 is transmitted to the multiply-accumulate circuit 1122_2 and the register REG111 through the multiplexer MUX112, and the element X03 of the memory 1115 is transmitted to the multiply-accumulate circuit 1122_3 and the register REG112 through the multiplexer MUX113. Therefore, after the MAC operation of the first period is completed, the element Y00 is X00*Z00, the element Y01 is X01*Z00, the element Y02 is X02*Z00, and the element Y03 is X03*Z00.

During the second period, the memory 1111 provides the element Z01 to the multiply-accumulate circuits 1122_0-1122_3. The element X01 of the register REG110 is transmitted to the multiply-accumulate circuit 1122_0 through the multiplexer MUX110, the element X02 of the register REG111 is transmitted to the multiply-accumulate circuit 1122_1 and the register REG110 through the multiplexer MUX111, the element X03 of the register REG112 is transmitted to the multiply-accumulate circuit 1122_2 and the register REG111 through the multiplexer MUX112, and the element X04 of the memory 1112 is transmitted to the multiply-accumulate circuit 1122_3 and the register REG112 through the multiplexer MUX114 and the multiplexer MUX113. Therefore, after the MAC operation of the second period is completed, the element Y00 is X00*Z00+X01*Z01, the element Y01 is X01*Z00+X02*Z01, the element Y02 is X02*Z00+X03*Z01, and the element Y03 is X03*Z00+X04*Z01.

During the third period, the memory 1111 provides the element Z02 to the multiply-accumulate circuits 1122_0-1122_3. The element X02 of the register REG110 is transmitted to the multiply-accumulate circuit 1122_0 through the multiplexer MUX110, the element X03 of the register REG111 is transmitted to the multiply-accumulate circuit 1122_1 and the register REG110 through the multiplexer MUX111, the element X04 of the register REG112 is transmitted to the multiply-accumulate circuit 1122_2 and the register REG111 through the multiplexer MUX112, and the element X05 of the memory 1113 is transmitted to the multiply-accumulate circuit 1122_3 and the register REG112 through the multiplexer MUX114 and the multiplexer MUX113. Therefore, after the MAC operation of the third period is completed, the element Y00 is X00*Z00+X01*Z01+X02*Z02, the element Y01 is X01*Z00+X02*Z01+X03*Z02, the element Y02 is X02*Z00+X03*Z01+X04*Z02, and the element Y03 is X03*Z00+X04*Z01+X05*Z02.

It will be apparent to those skilled in the art that various modifications and variations can be made to the disclosed embodiments without departing from the scope or spirit of the invention. In view of the foregoing, it is intended that the invention covers modifications and variations provided they fall within the scope of the following claims and their equivalents.

What is claimed is:

1. A convolution operation device, comprising:
a first memory configured to store a convolution kernel;
a second memory configured to store a first element of a matrix;
a third memory configured to store a second element of the matrix;
a first multiply-accumulate circuit coupled to the first memory to access the convolution kernel;
a second multiply-accumulate circuit coupled to the first memory to access the convolution kernel; and
a routing and shift register circuit coupled to the second memory, the third memory, the first multiply-accumulate circuit, and the second multiply-accumulate circuit, wherein
during a first period, the routing and shift register circuit transmits the first element of the second memory to the first multiply-accumulate circuit, and the routing and shift register circuit transmits the second element of the third memory to the second multiply-accumulate circuit; and
during a second period, the routing and shift register circuit transmits the second element of the third memory to the first multiply-accumulate circuit.

2. The convolution operation device according to claim 1, wherein a first part of the matrix is stored in the second memory, a second part of the matrix is stored in the third memory, and the first part is mutually exclusive from the second part.

3. The convolution operation device according to claim 1, wherein the first multiply-accumulate circuit comprises:
a register having an input terminal coupled to the first memory; and
a multiply-accumulate operator having a first input terminal coupled to an output terminal of the register, wherein a second input terminal of the multiply-accumulate-accumulate operator is coupled to the routing and shift register circuit.

4. The convolution operation device according to claim 1, further comprising:
a fourth memory configured to store a third element of the matrix; and
a third multiply-accumulate circuit coupled to the first memory to access the convolution kernel, wherein
during the first period, the routing and shift register circuit further transmits the third element of the fourth memory to the third multiply-accumulate circuit;
during the second period, the routing and shift register circuit further transmits the third element of the fourth memory to the second multiply-accumulate circuit; and
during a third period, the routing and shift register circuit transmits the third element of the fourth memory to the first multiply-accumulate circuit.

5. The convolution operation device according to claim 1, wherein the routing and shift register circuit comprises:
a first multiplexer having a first input terminal coupled to the second memory;
a first register having an input terminal coupled to an output terminal of the first multiplexer, wherein an output terminal of the first register is coupled to the first multiply-accumulate circuit;
a second multiplexer having a first input terminal coupled to the third memory; and
a second register having an input terminal coupled to an output terminal of the second multiplexer, wherein an output terminal of the second register is coupled to a second input terminal of the first multiplexer and the second multiply-accumulate circuit.

6. The convolution operation device according to claim 5, wherein the routing and shift register circuit further comprises:
a third multiplexer having a first input terminal coupled to a fourth memory of the convolution operation device; and
a third register having an input terminal coupled to an output terminal of the third multiplexer, wherein an output terminal of the third register is coupled to a second input terminal of the second multiplexer and a third multiply-accumulate circuit of the convolution operation device.

7. The convolution operation device according to claim 6, wherein a second input terminal of the third multiplexer receives a padding element.

8. The convolution operation device according to claim 6, wherein an output terminal of the third register is further coupled to a third input terminal of the first multiplexer.

9. The convolution operation device according to claim 6, wherein the routing and shift register circuit further comprises:
a fourth multiplexer, wherein a first input terminal of the fourth multiplexer is coupled to the second memory, a second input terminal of the fourth multiplexer is coupled to the third memory, a third input terminal of the fourth multiplexer is coupled to the fourth memory, and an output terminal of the fourth multiplexer is coupled to a second input terminal of the third multiplexer.

10. The convolution operation device according to claim 9, wherein a fourth input terminal of the fourth multiplexer receives a padding element.

11. The convolution operation device according to claim 9, wherein the routing and shift register circuit further comprises:
a fifth multiplexer, wherein a first input terminal of the fifth multiplexer is coupled to the second memory, a second input terminal of the fifth multiplexer is coupled to the third memory, a third input terminal of the fifth multiplexer is coupled to the fourth memory, a fourth input terminal of the fifth multiplexer receives a padding element, and an output terminal of the fifth multiplexer is coupled to a third input terminal of the second multiplexer.

12. The convolution operation device according to claim 1, wherein the routing and shift register circuit comprises:
a first multiplexer having a first input terminal coupled to the second memory, wherein an output terminal of the first multiplexer is coupled to the first multiply-accumulate circuit;
a second multiplexer having a first input terminal coupled to the third memory, wherein an output terminal of the second multiplexer is coupled to the second multiply-accumulate circuit; and
a first register having an input terminal coupled to the output terminal of the second multiplexer, wherein an output terminal of the first register is coupled to a second input terminal of the first multiplexer.

13. The convolution operation device according to claim 12, wherein the routing and shift register circuit further comprises:
a third multiplexer having a first input terminal coupled to a fourth memory of the convolution operation device, wherein an output terminal of the third multiplexer is coupled to a third multiply-accumulate of the convolution operation device; and
a second register having an input terminal coupled to an output terminal of the third multiplexer, wherein an output terminal of the second register is coupled to a second input terminal of the second multiplexer.

14. The convolution operation device according to claim 12, wherein the routing and shift register circuit further comprises:
a fourth multiplexer, wherein a first input terminal of the fourth multiplexer is coupled to the second memory, a second input terminal of the fourth multiplexer is coupled to the third memory, a third input terminal of the fourth multiplexer is coupled to the fourth memory, and an output terminal of the fourth multiplexer is coupled to a second input terminal of the third multiplexer.

15. The convolution operation device according to claim 14, wherein a fourth input terminal of the fourth multiplexer receives a padding element.
